(19) United States
(12) Patent Application Publication
(10) Pub. No.: US 2007/0166015 A1
(43) Pub. Date: Jul. 19, 2007

(54) Recording device and method

(75) Inventors: Martinus Wilhelmus Blum, Nijmegen (NL); Bart Van Rompaey, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,010

(22) PCT Filed: Jul. 7, 2005
(86) PCT No.: PCT/IB05/52259

§ 371 Date: Jan. 12, 2007

(30) Foreign Application Priority Data
Jul. 15, 2004 (EP) 04103397.8

(51) Int. Cl. H04N 5/00

(52) U.S. Cl. 386/126

(57) ABSTRACT

The present invention relates to a recording device (1) and a corresponding recording method for recording user data in a user area (UA) on a recordable or rewritable optical record carrier (4) comprising OPC means (3) for performing optical power calibration by writing OPC test data on a record carrier (4) before user data are recorded thereon. To avoid the problem that no more user data can be recorded on the record carrier since an OPC area (40) particularly reserved for writing said OPC test data is full, and to enable the provision of a smaller OPC area (40), it is proposed according to the present invention that the OPC test data are written in said user area (41, 42) if the OPC area (40) reserved for writing said OPC test data is not usable or not provided on the record carrier (4).

The present invention relates to a recording device and a corresponding recording method for recording user data in a user area on a recordable or rewritable optical record carrier, said recording device comprising means for performing optimum power calibration (OPC) by writing OPC test data on the record carrier before user data are recorded thereon. The invention further relates to a record carrier as well as to a computer program for implementing said recording method on a computer.

Only a limited area is available on current recordable and rewritable optical record carriers for performing an optical power calibration (OPC) procedure. Such an optical power calibration (OPC) procedure has to be done to determine the write powers that give the best recorded data quality. A new calibration is usually performed each time a record carrier is loaded into a drive. For rewritable record carriers the limited space of the OPC area, which is an area reserved for writing OPC test data, is generally not a serious problem because the OPC test data written during previous runs can be erased and/or overwritten. On recordable (that is, write-once) record carriers, however, the OPC area can become full so that no new OPC procedure can be performed anymore. In this case no more user data can be recorded on said record carrier, even if there is still space available in the user area. The (predetermined) size of the OPC area should therefore be chosen such that this will never happen, or at least only very rarely.

However, on small record carriers such as, for example, a Portable Blue system, space is limited. In this case the OPC area should preferably be chosen as small as possible to provide as much space as possible for recording user data. Selecting a small OPC area will increase the possibility that the OPC area is too small and that the record carrier cannot be written to anymore because no space is available to perform an OPC procedure.

It is accordingly an object of the present invention to provide a recording device and a corresponding recording method which overcome this problem.

This object is achieved according to the present invention by providing a recording device wherein the OPC means are adapted for writing the OPC test data in the user area if an OPC area reserved for writing said OPC test data is not usable anymore or if such an OPC area is not provided on the record carrier. Corresponding recording methods are defined in claims 13, 14 and 15. A computer program for implementing said recording method on a computer is defined in claim 17.

Furthermore, the invention relates to a record carrier on which user data can be recorded in a user area, storing OPC test data written on the record carrier for performing an optimum power calibration (OPC) before user data can be recorded on the record carrier, the OPC test data being written in said user area.

The present invention is based on the idea that the user area, intended for storing user data, can be used as an overflow area for writing OPC test data in any case in which the OPC area is either full or not usable for any other reason, or even if such an OPC area is not provided on the record carrier at all. The OPC area specifically reserved for writing the OPC test data can thus be made much smaller, or even be completely omitted.

The user area provides sufficient space for writing OPC test data for performing an OPC procedure in case the OPC area is full or not provided.

Preferred embodiments of the invention are defined in the dependent claims. In a preferred embodiment, search means are provided for searching an area in the user area having sufficient space for writing said OPC test data. This provides the advantage that not just any area in the user area will be used, but only an area where sufficient space is available for writing all OPC test data for one calibration sequentially (that is, without any user data in between). In a further embodiment, an area is searched for where still sufficient space is available as a kind of guard area between the actual user data and the OPC test data after writing of the OPC test data. This serves to avoid that the OPC test data damages the user data in the neighboring areas.

Preferably, said search means are adapted for searching an area in the user area for writing the OPC test data comprising at least three consecutive tracks. This is because generally at least one track is required for writing the OPC test data for one OPC procedure. In a preferred embodiment thereof, one or more central tracks of said at least three consecutive tracks are used for writing said OPC test data, and the outer tracks of said at least three consecutive tracks are used as safety areas (buffer areas) to prevent damage to the user data in neighboring tracks of the user area. This is preferred because the OPC procedure might corrupt user data in the neighboring tracks if such a safety area is omitted. Furthermore, cross-talk of the user data in neighboring areas may influence the OPC test data. Preferably, no data of any kind is recorded in the safety area (buffer area) during the OPC procedure. It is noted that some OPC procedures do not require a full revolution of the disc, but only, for example, the length of a single ECC cluster. Consequently, the safety area could then also be selected to be smaller.

In a still further advantageous embodiment, marking means are provided for marking the portion of said user area used by an OPC calibration procedure for recording OPC test patterns as being unusable for the recording and/or reading of user data. In particular, such marking means are provided for marking said portion as defective or containing invalid data. This avoids that the drive attempts to read back the OPC test data assuming it is normal user data since the OPC test data is generally not written according to the data format of the user data.

The terms “user data” and “user area” should be understood broadly. “User area” also includes, for example, the spare areas that a defect management system uses when it has to replace a defective cluster. Such areas may also be used for writing OPC test patterns according to the present invention, in the same way as the normal user data area.

The invention will now be explained in more detail with reference to the accompanying drawings, in which:

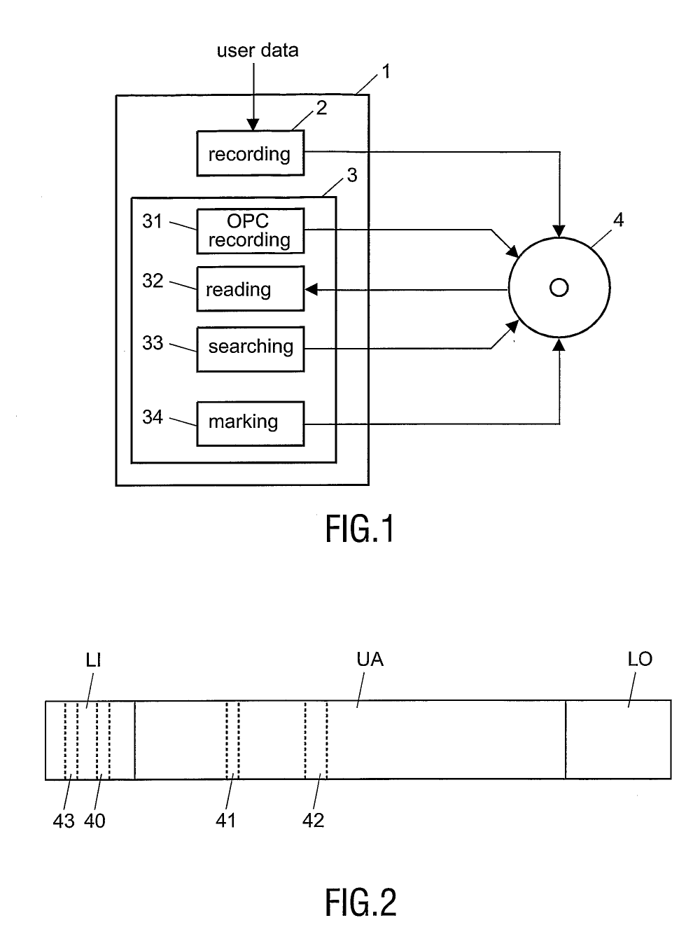

FIG. 1 shows a block diagram of a recording device according to the present invention, and

FIG. 2 shows a physical layout of a record carrier according to the present invention.

FIG. 1 schematically shows an embodiment of a recording device 1 according to the present invention comprising a recording unit 2 for recording user data on an optical record carrier 4, such as a recordable or rewritable CD, DVD, or BD disc, and OPC means 3 for performing an optimum power calibration. The OPC means 3 comprise an OPC recording unit 31 by which OPC test data are recorded on the record carrier 4, and a reading unit 32 for reading the recorded OPC test data which are subsequently analyzed to optimize the write power used subsequently for recording of the user data by the recording unit 2. The method of performing an optimum power calibration is generally known in the art and will not be described in more detail here. For example, EP 1 128 373 A2 and U.S. Pat. No. 6,052,347 describe optimum power calibration methods where the OPC test data are written in an OPC area that is specifically allocated for this purpose. It is noted that, although the recording unit 2 for recording user data and the OPC recording unit 31 are shown as separate blocks in FIG. 1, they may have some hardware in common such as, for example, a laser source for generating a laser beam an a lens for focusing the laser beam on the record carrier (not shown in the schematic block diagram of FIG. 1).

In order to avoid the problem discussed above that either no more user data can be recorded on the record carrier 4 when the OPC area is full or not usable for any other reason, for example when it is defective, or that the OPC area must be chosen to be relatively large, the OPC means 3 according to the invention further comprise a search means 33 which searches for an area in the user area of the record carrier 4 where sufficient space is available for writing test data for one run of an optimum power calibration procedure. For example, the search means 33 may search for an area where at least three consecutive tracks are available. The central track is then used for writing the OPC test data for one run, while the outer tracks serve as a buffer between the OPC test data and the user data in the neighboring tracks. This is advantageous because the OPC procedure might corrupt user data previously recorded in the neighboring tracks. Such a search for sufficient space in the user area is performed each time before the OPC test data are actually written.

In a next step the OPC procedure will actually be performed. Special OPC test data is written during this procedure. This step is generally known.

Since the OPC test data is generally not according to the data format of the user data, a drive should not attempt to read back the data assuming it is normal user data. Therefore, the OPC means 3 additionally comprise a marking means 34 for marking the area where the OPC test data has been written. This area where the OPC test data has been written may, for example, be marked by the files system as an area with invalid data or, alternatively, by a defect management system as a defective (i.e. unusable) area.

This is also illustrated in FIG. 2 showing a physical layout of a record carrier 4 comprising a lead-in area LI, a user area UA, and a lead-out area LO. Generally, an OPC area is provided for writing the OPC test data of all OPC procedures in the lead-in area LI. However, if this OPC area 40 is full, not usable for any other reason, or even not provided on the record carrier at all, no more user data can be written in the user area UA even if there were sufficient space available in the user area UA. According to the present invention, the OPC test data will now be written in the user area UA. In an embodiment, the OPC test data will be written in dynamically selected OPC areas 41, 42 having sufficient space for writing all of the OPC test data for one OPC procedure. Preferably, these dynamically selected OPC areas 41, 42 should have sufficient space for additional guard areas serving as a buffer for separating the OPC test data from the user data recorded in neighboring tracks.

To avoid that the OPC test data written in such dynamic OPC areas 41, 42 are erroneously interpreted as user data, they are preferably marked as invalid data in a file system or as defective areas in a defect management system, for example in a defect management table 43 provided in the lead-in area LI on the record carrier.

Preferably, the dynamic OPC areas 41, 42 should be marked such that it is possible for a drive to distinguish between areas that cannot be used because they contain defects and areas that cannot be used because they contain OPC test data. Otherwise a user scanning the disc with a special software program that analyzes the disc on a low level might think that the disc is defective and therefore unreliable, although in reality the disc may be perfect, merely because an OPC procedure was performed in the user area. It is noted that the guard areas serving as a buffer may also be marked as described above.

Generally, the area used for writing OPC test data is marked, for example by means of the defect management system, at the moment when the OPC procedure is performed. Alternatively, an OPC area in the user area may be reserved beforehand, that is before any OPC procedures are performed. In this way a new OPC area is created in the user area through marking by the defect management system.

It is noted that the preferred place for the search means to start a search for sufficient space is the location where the OPC test data of the previous OPC procedure was written, provided that at least one previous OPC procedure was already performed in the user area.

1. Recording device (1) for recording user data in a user area (UA) on a recordable or rewritable optical record carrier (4), said recording device comprising OPC means (3) for performing an optimum power calibration procedure by writing OPC test data on the record carrier (4), said OPC means (3) being adapted for writing said OPC test data in said user area (UA; 41, 42).

2. Recording device as claimed in claim 1, wherein said OPC means (3) are adapted for writing said OPC test data in said user area (UA; 41, 42) if an OPC area (40) reserved for writing said OPC test data is not usable.

3. Recording device as claimed in claim 2, wherein said OPC means (3) are adapted for writing said OPC test data in said user area (UA) if said reserved OPC area (40) is full.

4. According device as claimed in claim 1, wherein said OPC′ means (3) are adapted for writing said OPC test data in said user area (UA; 41, 42) if an OPC′ area reserved for writing OPC test data is not provided on said record carrier.

5. Recording device as claimed in claim 1, further comprising search means (33) for searching for an area in the user area (UA) having sufficient space for writing said OPC test data.

6. Recording device as claimed in claim 5, wherein said search means (33) are adapted for searching for an area (41, 42) in the user area (UA) for writing the OPC test data comprising at least three consecutive tracks.

7. Recording device as claimed in claim 6, wherein the one or more central tracks of said at least three consecutive tracks are used for writing said OPC test data, and wherein the outer tracks of said at least three consecutive tracks are used as safety areas to prevent damage to user data previously recorded in neighboring tracks in the user area (UA).

8. Recording device as claimed in claim 7, wherein the OPC means (3) do not write any data to the tracks in the safety areas.

9. Recording device as claimed in claim 1, further comprising marking means (34) for marking the portion of said user area (UA) used for writing OPC test data as unusable for recording and/or reading of user data.

10. Recording device as claimed in claim 9, wherein the marking means are adapted for marking said portion of said user area (UA) used for writing OPC test data as defective.

11. Recording device as claimed in claim 10, wherein the marking means are adapted for marking said portion of said user area (UA) used for writing OPC test data as defective such that they are distinguishable from portions of said user area marked as defective for any other reason.

12. Recording device as claimed in claim 9, wherein the marking means are adapted for marking the data recorded in said portion of said user area (UA) used for writing OPC test data as invalid data.

13. Recording method for recording user data in a user area (UA) on a recordable or rewritable optical record carrier (4), comprising the step of performing an optimum power calibration procedure by writing OPC test data on the record carrier (4), wherein said OPC test data are written in said user area (UA; 41, 42).

14. Recording method as claimed in claim 13, wherein said OPC test data are written in said user area (UA; 41, 42) if an OPC area (40) reserved for writing said OPC test data is not usable.

15. Recording method as claimed in claim 13, wherein said OPC test data are written in said user area (UA; 41, 42) if an OPC area reserved for writing said OPC′ test data is not provided on the record carrier.

16. Record carrier (4) on which user data can be recorded in a user area (UA), said record carrier storing OPC test data written on the record carrier (4) in said user area (41, 42) for performing an optimum power calibration procedure.

17. Computer program comprising computer program means for causing a computer to carry out the steps of the method as claimed in claim 13 when said computer program is run on a computer.
